(19) United States
(12) Patent Application Publication
(10) Pub. No.: US 2019/0218355 A1
(43) Pub. Date: Jul. 18, 2019

(54) METHOD FOR PRODUCING A CROSS-LINKED MOULDED BODY FROM UHMWPE

(71) Applicant: Aesculap AG, Tuttlingen (DE)

(72) Inventors: Marie Anne Mulliez, Tuttlingen (DE); Gerhard Reu, Tuttlingen (DE)

(21) Appl. No.: 16/275,466

(22) Filed: Feb. 14, 2019

Related U.S. Application Data
(63) Continuation of application No. PCT/EP2017/070989, filed on Aug. 21, 2017.

(30) Foreign Application Priority Data
Sep. 6, 2016 (DE) 10 2016 116 597.2

(51) Int. Cl. C08J 7/12; G01V 5/10; B27N 3/08

(52) U.S. Cl. CPC C08J 7/123; B29C 59/14; B27N 3/08; G01V 5/104

(57) ABSTRACT

The present invention relates to a method for producing a cross-linked moulded body from UHMWPE, comprising the steps of: providing a moulded body from UHMWPE which is added with an antioxidant; heating the moulded body to a temperature of 100° C. or more; and irradiating the moulded body in order to cross-link the UHMWPE in the moulded body. The irradiation of the moulded body is carried out with x-ray radiation. The invention also relates to a method for producing an implant or an implant part, in particular an inlay for an artificial hip joint, comprising the performance of the above method and the machining of the cross-linked moulded body.

### CROSS-REFERENCE TO RELATED APPLICATIONS

This application is a continuation of international application No. PCT/EP2017/070989 filed on Aug. 21, 2017 and claims the benefit of German application No. 10 2016 116 597.2 filed on Sep. 6, 2016, which are incorporated herein by reference in their entirety and for all purposes.

### FIELD OF THE INVENTION

The present invention relates to a method for producing a cross-linked moulded body from UHMWPE, comprising the steps:
providing a moulded body from UHMWPE which is added with an antioxidant;
heating the moulded body to a temperature of 100° C. or more; and
irradiating the moulded body in order to cross-link the UHMWPE in the moulded body.

The invention further relates to a method for producing an implant or an implant part, comprising the performance of the method described above and the machining of the cross-linked moulded body.

### BACKGROUND OF THE INVENTION

Ultrahigh molecular weight polyethylene (UHMWPE) is a plastics material which, due to its excellent mechanical properties, has long been used for the production of orthopedic implants, in particular of inlays for artificial hip joints or other joint prostheses. Among other things, UHMWPE has a high mechanical strength and hardness, a low friction coefficient, and a high resistance to wear. In order to increase in particular the resistance to wear and thus the lifespan of the implants, it is common to cross-link the UHMWPE by the action of beta radiation and/or gamma radiation.

Because the radiation cross-linking occurs by way of a free radical reaction mechanism, free radicals remain in the UHMWPE after the irradiation, which make the material susceptible to oxidation processes and thus, in turn, can negatively influence the product properties. To avoid this problem, it is also known from the prior art to add the UHMWPE with an antioxidant like, e.g., α-tocopherol (vitamin E) in order to capture the free radicals remaining after the cross-linking.

Methods of that kind for producing cross-linked moulded bodies from UHMWPE using beta or gamma radiation are described, e.g., in the international patent application WO 2007/019874 A1.

Both kinds of the ionizing radiation used, however, involve certain disadvantages. In the case of beta radiation, which is a particle radiation, this is primarily the limited penetration depth into the UHMWPE moulded body of at most about 40 mm, such that a continuously homogeneous cross-linking of larger moulded bodies is not possible. The irradiated moulded bodies (e.g. blanks in the form of slabs or bars) have, however, mostly for technical reasons, a larger dimension in one spatial direction, such that the non-cross-linked portion must in each case be discarded, which is correspondingly uneconomical.

In the case of the gamma radiation, the problem of the limited penetration depth is no longer applicable, but what is extremely disadvantageous here is the significantly lesser dose rate of the available radiation sources (radioactive isotopes like, e.g., cobalt-60) in comparison to the beta radiation. As a result, longer irradiation times are necessary to achieve the desired dose, which is also economically disadvantageous, among other things because also no thermal irradiation is possible. A further disadvantage of gamma radiation is the limited reproducibility and controllability, respectively, of the radiation power.

Therefore, the object underlying the invention is to propose a method for producing a cross-linked moulded body from UHMWPE in which the stated problems are entirely or partially avoided.

### SUMMARY OF THE INVENTION

One aspect of the invention relates to a method for producing a cross-linked moulded body from UHMWPE, comprising the steps:
providing a moulded body from UHMWPE which is added with an antioxidant;
heating the moulded body to a temperature of 100° C. or more; and
irradiating the moulded body in order to cross-link the UHMWPE in the moulded body,
   wherein that the irradiation of the moulded body is carried out with x-ray radiation.

Another aspect of the invention relates to a method for producing an implant or an implant part, in particular an inlay for an artificial hip joint, comprising the performance of the above method and the machining of the cross-linked moulded body.

When using x-ray radiation for cross-linking the UHMWPE moulded body, sufficiently high dose rates may be achieved, such that shorter irradiation times and a thermal irradiation are possible. In addition, the control and reproducibility of the radiation power are unproblematic with x-ray radiation. For a consistent product quality, this is of great importance, particularly in the case of medical products. On the other hand, x-ray radiation has, in comparison to the beta radiation, a significantly higher penetration depth which is not limiting, at least for the practically relevant dimensions of the moulded bodies to be irradiated.

The method in accordance with the invention thus combines significant advantages which are each only able to be achieved individually with the use of beta radiation or gamma radiation.

### DETAILED DESCRIPTION OF THE INVENTION

As an antioxidant with which the UHMWPE is added, various antioxidizing agents may be used which are also approved for use in the medical field. The antioxidant is preferably selected from tocopherols, tocotrienols, ascorbic acid, polyphenolic antioxidants like, e.g., flavonoids, butylhydroxytoluol (BTH), and butylhydroxyanisole (BTA).

In a preferred embodiment of the invention, the antioxidant is α-tocopherol. This is also referred to as vitamin E, the term vitamin E comprising in a broader sense all tocopherols, tocotrienols, and further fat-soluble antioxidants.

The moulded body which serves as a starting point for the method in accordance with the invention is preferably produced by mixing pulverulent and granular UHMWPE with the antioxidant and then compacting the mixture, in particular by means of compression moulding or ram extrusion. Due to the high melt viscosity of UHMWPE, a processing by means of a conventional method for working plastics (e.g. injection molding) is typically not possible or impractical.

The amount of the antioxidant in the moulded body is preferably in the range of 0.02 to 2% by weight, further preferably of 0.05 to 0.5% by weight, and in particular at about 0.1% by weight. This quantity has proven to be sufficient in order to largely prevent the disadvantageous effects of free radicals.

UHMWPE is produced through the Ziegler-Natta method using appropriate catalysts. The UHMWPE used within the scope of the invention typically has a molecular weight in the range of 5.10⁶ to 10⁷ g/mol (determined from the intrinsic viscosity) and a density in the range of 0.92 to 0.94 g/cm³. Suitable types of UHMWPE in powder form are obtainable, e.g., from Ticona GmbH under the name GUR 1020 and GUR 1050 and, respectively, as a mixture added with 0.1% by weight α-tocopherol under the name GUR 1020-E and GUR 1050-E.

Typically the moulded body made from the UHMWPE added with antioxidant has a dimension of 50 mm or more in each spatial direction, and preferably of 100 mm or more in one spatial direction. Moulded bodies with corresponding dimensions may be used as blanks for the production of implants or implant parts, wherein the penetration depth of the x-ray radiation, as already described above, is not limiting in this field, such that a continuously homogeneous cross-linking of the UHMWPE is ensured.

The upper limits for the dimensions of the moulded body thus arise only from the constructive circumstances of the irradiation apparatus, wherein it is favorable for a process control which is as economical as possible to optimally utilize the space available in the apparatus with a multitude of moulded bodies.

In the method in accordance with the invention, the moulded body is heated to a temperature of 90° C. or more, such that the subsequent irradiation is carried out at an increased temperature of the moulded body. As a result of this heating, the mobility of the molecular chains of the UHMWPE is increased and thus also the rate of reaction of the cross-linking via the radicals generated by means of the radiation. The effectiveness of the radiation cross-linking is thereby increased. Due to the irradiation times provided (see below), it is hereby sufficient in the scope of the invention to preheat the moulded body, such that it retains a sufficiently high temperature during the entire duration of the irradiation, despite a degree of cooling. A heating during the irradiation, which means an additional expenditure on equipment, may, however, be foregone. This constitutes a further advantage of shorter irradiation times (in particular in comparison to gamma irradiation).

The heating of the moulded body is preferably carried out in such a way that the moulded body retains a temperature of 90° C. or more during the irradiation. Which heating temperature is necessary for this depends on various influencing factors, in particular also on the dimensions of the moulded body. So that the moulded body cools off as slowly as possible, it is preferable for it to be arranged in a thermal insulation during the irradiation.

In a preferred embodiment of the invention, the heating is carried out to a temperature below the melting point of the UHMWPE, which is at about 135° C. The moulded body is preferably heated to a temperature of 105 to 130° C., further preferably of 110 to 120° C. In the latter case, the temperature of the moulded body typically sinks during the irradiation to about 100° C., which is usually sufficient for an effective cross-linking.

In a further embodiment of the invention, the moulded body is heated to a temperature in the range of or above the melting point of the UHMWPE, preferably to a temperature of 135 to 160° C. Above the melting point, the molecular mobility is, by nature, again significantly increased. However, this approach may, under certain circumstances, also lead to a degradation of the mechanical properties of the moulded body.

In accordance with an advantageous embodiment of the invention, the moulded body is irradiated with a radiation dose of 60 to 110 kGy, preferably of 65 to 100 kGy, further preferably of 70 to 90 kGy. Corresponding radiation doses have proven to be sufficient even with the use of beta radiation.

The irradiation is favorably performed with a dose rate of 10 to 30 kGy/h, preferably of 15 to 25 kGy/h. A sufficient x-ray power to achieve this dose rate may be generated, e.g., by means of a Rhodotron.

Taking into account the radiation doses and dose rates stated above, for the method in accordance with the invention, it results in an irradiation period which is typically in the range of 3 to 7 hours, preferably in the range of 4 to 5 hours. In contrast, irradiation times of 16 to 24 hours are typically necessary with the use of gamma radiation.

The cross-linked moulded body from UHMWPE preferably serves as a blank for the production of an implant or implant part by machining, in particular by turning and milling.

Subject matter of the present invention is therefore also a method for producing an implant or an implant part, in particular and inlay for an artificial hip joint, comprising the performance of the method in accordance with the invention for producing a cross-linked moulded body from UHMWPE and the machining of the cross-linked moulded body.

The moulded body is favorably not subjected to any thermal aftertreatment between the irradiation and the machining. If the irradiation is performed at a sufficiently high temperature, then such a thermal aftertreatment (annealing) is not necessary for achieving a high degree of cross-linking and, on the contrary, may degrade the mechanical properties of the moulded body.

The implant or implant part produced may then be packaged and sterilized by means of ethylene oxide.

### EXAMPLE

### 1. Production of Moulded Bodies

Starting point for the production of the moulded bodies is pulverulent UHMWPE (GUR 1020-E, Ticona GmbH), which is produced in accordance with ISO 5834-1:2005 (UHMWPE in powder form for surgical implants) and is added with 0.1% by weight α-tocopherol (vitamin E). Plate-shaped semi-finished products are produced from this mixture by means of compression moulding (pressure sintering process at a temperature of about 220° C. and a pressure of about 50 bar). The plates are then tempered at about 110° C. for 15 to 25 hours.

Moulded bodies for the performance of the method in accordance with the invention are cut from the plates in the form of bars with the following dimensions: 50·50·940 mm, 55·55·940 mm, and 60·60·940 mm.

### 2. Heating of the Moulded Bodies

The moulded bodies are heated over a period of 10 to 20 hours at a temperature of 115° C. with the goal that the temperature is in the range of about 100° C. during the subsequent irradiation. The relatively long heating duration is selected in order to ensure that the heating temperature is also fully reached in the interior of the moulded body. Because the heating temperature is significantly below the melting temperature of the UHMWPE, a longer tempering does not involve negative effects.

### 3. Irradiation of the Moulded Bodies

The moulded bodies are placed in a thermal insulation into an x-ray irradiation apparatus and are irradiated during a period of about four hours with a dose rate of about 20 kGy/h. The radiation dose absorbed by the moulded bodies is thus at about 80 kGy.

The temperature of the moulded bodies is at about 100° C. or more during the entire irradiation period. After the irradiation, the moulded bodies are left in the thermal insulation to slowly cool.

### 4. Production of Implant Parts

First, rods with a length of 940 mm and a diameter of 50, 55, and 60 mm, respectively, are formed from the various moulded parts (bars) by turning. From these rods are produced, e.g., inlays for artificial hip joints through further machining. The hip inlays are packaged and sterilized by means of ethylene oxide.

What is claimed is:

1. A method for producing a cross-linked moulded body from UHMWPE, comprising the steps:
providing a moulded body from UHMWPE which is added with an antioxidant;
heating the moulded body to a temperature of 100° C. or more; and
irradiating the moulded body in order to cross-link the UHMWPE in the moulded body,
wherein the irradiation of the moulded body is carried out with x-ray radiation.

2. The method in accordance with claim 1, wherein the antioxidant is selected from tocopherols, tocotrienols, ascorbic acid, polyphenolic antioxidants, butylhydroxytoluol, and butylhydroxyanisole.

3. The method in accordance with claim 2, wherein the antioxidant is α-tocopherol.

4. The method in accordance with claim 1, wherein the moulded body is produced by mixing pulverulent or granular UHMWPE with the antioxidant and then compacting the mixture.

5. The method in accordance with claim 1, wherein the amount of the antioxidant in the moulded body is in the range of 0.02 to 2% by weight.

6. The method in accordance with claim 1, wherein the UHMWPE has a molecular weight in the range of 5*10⁶ to 10⁷ g/mol and a density in the range of 0.92 to 0.94 g/cm³.

7. The method in accordance with claim 1, wherein the moulded body has a dimension of 50 mm in each spatial direction.

8. The method in accordance with claim 1, wherein the heating of the moulded body is carried out in such a way that the moulded body retains a temperature of 90° C. or more during the irradiation.

9. The method in accordance with claim 1, wherein the moulded body is arranged in a thermal insulation during the irradiation.

10. The method in accordance with claim 1, wherein the heating is carried out to a temperature below the melting point of the UHMWPE.

11. The method in accordance with claim 1, wherein the heating is carried out to a temperature in the range of or above the melting point of the UHMWPE.

12. The method in accordance with claim 1, wherein the moulded body is irradiated with a radiation dose of 60 to 110 kGy.

13. The method in accordance with claim 1, wherein the irradiation is performed with a dose rate of 10 to 30 kGy/h.

14. The method in accordance with claim 1, wherein the irradiation is performed during a period of 3 to 7 hours.

15. A method for producing an implant or an implant part, comprising the performance of the method in accordance with claim 1 and the machining of the cross-linked moulded body.

16. The method in accordance with claim 15, wherein the moulded body is not subjected to any thermal aftertreatment between the irradiation and the machining.

17. The method in accordance with claim 15, wherein the implant or implant part is packaged and sterilized by means of ethylene oxide.

18. The method in accordance with claim 10, wherein the heating is carried out to a temperature of 110 to 120° C.

19. The method in accordance with claim 18, wherein the heating is carried out over a period of 10 to 20 hours at a temperature of 115° C.

20. The method in accordance with claim 8, wherein the heating of the moulded body is carried out in such a way that the moulded body retains a temperature of about 100° C. during the irradiation.
